(19) United States
(12) Patent Application Publication
(10) Pub. No.: US 2020/0371220 A1
(43) Pub. Date: Nov. 26, 2020

(54) MULTI-STATIC WIRELESS SENSING

(71) Applicant: QUALCOMM Incorporated, San Diego, CA (US)

(72) Inventors: Alecsander Petru EITAN, Haifa (IL); Assaf Yaakov KASHER, Haifa (IL); Solomon TRAININ, Haifa (IL)

(21) Appl. No.: 16/789,684

(22) Filed: Feb. 13, 2020

Related U.S. Application Data
(60) Provisional application No. 62/850,342, filed on May 20, 2019.

(51) Int. Cl. G01S 13/00; G01S 13/04; G01S 13/89; G01S 13/87

(52) U.S. Cl. CPC G01S 13/003; G01S 13/04; H04W 84/12; G01S 13/878; G01S 13/89

(57) ABSTRACT

This disclosure provides methods, apparatuses, wireless nodes and computer-readable mediums for wireless communications. In one aspect, wireless, or WiFi, sensing involves a device transmitting WiFi signals, while another device, or devices, use reflections of those signals to map and measure the environment. WiFi sensing may be used to obtain rough dimensions of a room, identify stationary objects in a room, or detect objects (such as people) moving into, out of, or within a room. Multi-static WiFi sensing can occur when two devices are simultaneously transmitting and receiving WiFi signals.

### CROSS-REFERENCE TO RELATED APPLICATION(S)

The present application for patent claims priority to U.S. Provisional Application No. 62/850,342, filed May 20, 2019, which is assigned to the assignee of the present application and hereby expressly incorporated by reference herein in its entirety.

### TECHNICAL FIELD

This disclosure relates generally to multi-static wireless sensing, and more particularly to using wireless signals and their reflections to sense objects in an environment.

### DESCRIPTION OF THE RELATED TECHNOLOGY

The deployment of wireless local area networks (WLANs, sometimes referred to as WiFi networks) in the home, the office, and various public facilities is commonplace today. Such networks typically employ a wireless access point (AP) that connects a number of wireless stations (STAs) in a specific locality (such as the aforementioned home, office, public facility, etc.) to another network, such as the Internet or the like. A set of STAs can communicate with each other through a common AP in what is referred to as a basic service set (BSS).

WLAN sensing or WiFi sensing generally refers to a WLAN in which one or more WLAN devices monitor or map the environment by using standard WLAN signals. For example, a WiFi sensing system may use the signal reflections off of walls or other objects, including people, to map and measure the environment.

There are various types of WiFi sensing. Monostatic WiFi sensing generally refers to a system where the same WiFi device transmits the WiFi signal and receives the reflections to map the environment. This mode of operation is similar to conventional (monostatic) radar. Multi-static WiFi sensing generally refers to a system where at least two devices participate in the sensing, with one or more devices transmitting and one or more devices receiving. Wireless sensing may be extended beyond WiFi devices, for example, to devices compatible with 3GPP standards.

### SUMMARY

The methods, apparatuses and computer-readable mediums of this disclosure each have several innovative aspects, no single one of which is solely responsible for the desirable attributes disclosed herein.

One innovative aspect of the subject matter described in this disclosure can be implemented in a method for wireless communications by an apparatus. The method generally includes outputting, for transmission to at least one wireless node, at least one first frame with parameters for performing wireless sensing based on at least one reflection of at least one second frame off at least one object and participating in the wireless sensing with the at least one wireless node in accordance with the parameters.

Another innovative aspect of the subject matter described in this disclosure can be implemented in an apparatus for wireless communications. The apparatus generally includes means for outputting, for transmission to at least one wireless node, at least one first frame with parameters for performing wireless sensing based on at least one reflection of at least one second frame off at least one object and means for participating in the wireless sensing with the at least one wireless node in accordance with the parameters.

Another innovative aspect of the subject matter described in this disclosure can be implemented in an apparatus for wireless communications. The apparatus generally includes an interface configured to output, for transmission to at least one wireless node, at least one first frame with parameters for performing wireless sensing based on at least one reflection of at least one second frame off at least one object and a processing system configured to participate in the wireless sensing with the at least one wireless node in accordance with the parameters.

Another innovative aspect of the subject matter described in this disclosure can be implemented in a computer-readable medium for wireless communications. The computer-readable medium generally includes instructions executable to output, for transmission to at least one wireless node, at least one first frame with parameters for performing wireless sensing based on at least one reflection of at least one second frame off at least one object and participate in the wireless sensing with the at least one wireless node in accordance with the parameters.

In some implementations, the method, apparatuses and computer-readable medium can include participating in the wireless sensing and further may include operations, features, means, or instructions for outputting the at least one second frame for transmission or for monitoring for reflections of the at least one second frame.

In some implementations, the method, apparatuses, and computer-readable medium may include operations, features, means, or instructions for obtaining, from the at least one wireless node, data from the wireless sensing performed in accordance with the parameters and processing the data to generate a sensing result, in which the processing is based on known or estimated one or more locations of the at least one wireless node. Furthermore, the sensing result may indicate a position or presence of the at least one object or the sensing result may represent a map of an environment in which the wireless sensing is performed.

In some implementations, the method, apparatuses, and computer-readable medium may include operations, features, means, or instructions for obtaining, from one of the at least one wireless node, a request to initiate the wireless sensing prior to outputting the first frame for transmission. In further implementations, the parameters may include a schedule that indicates when the one wireless node that requested initiation of the wireless sensing is to output the at least one second frame for transmission and when the at least one wireless node, other than the one wireless node that requested initiation of the wireless sensing, is to output the at least one second frame for transmission during the wireless sensing. In further implementations, the method, apparatuses, and computer-readable medium may include operations, features, means, or instructions for selecting the parameters, in which the request indicates desired parameters for the wireless sensing and the selection of the parameters is, at least in part, based on the desired parameters indicated in the request. In further implementations, the method, apparatuses, and computer-readable medium may include operations, features, means, or instructions for obtaining, from the at least one wireless node, data from the wireless sensing performed in accordance with the parameters, processing the data to generate a sensing result and outputting, for transmission to the wireless node that sent the request, a third frame with the sensing result.

In some implementations, the method, apparatuses and computer-readable medium may include operations, features, means, or instructions in which the parameters include at least one of a parameter indicating when the wireless sensing is to start, a parameter indicating a duration of the wireless sensing or a parameter indicating a waveform definition for a signal in a portion of the at least one second frame.

In some implementations, the method, apparatuses and computer-readable medium may include operations, features, means, or instructions in which parameters include a schedule that indicates when the apparatus is to output the at least one second frame for transmission during the wireless sensing.

In some implementations, the method, apparatuses, and computer-readable medium may include operations, features, means, or instructions in which the at least one wireless node includes a plurality of wireless nodes and the parameters indicate a schedule for outputting the at least one second frame for transmission from different ones of the plurality of wireless nodes for the wireless sensing. In further implementations, the method, apparatuses, and computer-readable medium may include operations, features, means, or instructions in which the schedule calls for simultaneous transmission of the at least one second frame by at least two of the plurality of wireless node and at least a portion of each of the second frames includes at least one orthogonal signal. In further implementations, the method, apparatuses, and computer-readable medium may include operations, features, means, or instructions in which the at least one orthogonal signal includes one or more Golay codes.

Another innovative aspect of the subject matter described in this disclosure can be implemented in a method for wireless communications by an apparatus. The method generally includes obtaining, from at least one wireless node, at least one first frame with parameters for performing wireless sensing based on at least one reflection of at least one second frame off at least one object and participating in the wireless sensing with the apparatus, in accordance with the parameters.

Another innovative aspect of the subject matter described in this disclosure can be implemented in an apparatus for wireless communications. The apparatus generally includes means for obtaining, from at least one wireless node, at least one first frame with parameters for performing wireless sensing based on at least one reflection of at least one second frame off at least one object and means for participating in the wireless sensing with the at least one wireless node in accordance with the parameters.

Another innovative aspect of the subject matter described in this disclosure can be implemented in an apparatus for wireless communications. The apparatus generally includes an interface configured to obtain, from at least one wireless node, at least one first frame with parameters for performing wireless sensing based on at least one reflection of at least one second frame off at least one object and a processing system configured to participate in the wireless sensing with the at least one wireless node in accordance with the parameters.

Another innovative aspect of the subject matter described in this disclosure can be implemented in a computer-readable medium for wireless communications. The computer-readable medium generally includes instructions executable to obtain, from at least one wireless node, at least one first frame with parameters for performing wireless sensing based on at least one reflection of at least one second frame off at least one object and participate in the wireless sensing with the at least one wireless node in accordance with the parameters.

In some implementations, the method, apparatuses and computer-readable medium can include participating in the wireless sensing and further may include operations, features, means, or instructions for measuring data in accordance with the parameters and providing the data to the at least one wireless node.

In some implementations, the method, apparatuses and computer-readable medium can include participating in the wireless sensing and further may include operations, features, means, or instructions for outputting the at least one second frame for transmission.

In some implementations, the method, apparatuses and computer-readable medium can include participating in the wireless sensing and further may include operations, features, means, or instructions for monitoring for reflections of the at least one second frame. In further implementations, the method, apparatuses, and computer-readable medium may include operations, features, means, or instructions in which the parameters include a schedule that indicates when the apparatus is to output the at least one second frame for transmission during the wireless sensing. In further implementations.

In some implementations, the method, apparatuses, and computer-readable medium may include operations, features, means, or instructions in which the parameters include a schedule that indicates at least one of when the apparatus is to output the at least one second frame for transmission or when the at least one wireless node is to output at least one second frame for transmission during the wireless sensing.

In some implementations, the method, apparatuses and computer-readable medium can include participating in the wireless sensing and further may include operations, features, means, or instructions for measuring data in accordance with the parameters and processing the data to generate a sensing result. In further implementations, the method, apparatuses, and computer-readable medium may include operations, features, means, or instructions in which the processing is based on known or estimated one or more locations of the at least one wireless node or the sensing result indicates a position or presence of the at least one object and further in which the at least one object includes at least one person.

In some implementations, the method, apparatuses, and computer-readable medium may include operations, features, means, or instructions for outputting, for transmission to the at least one wireless node, a request to initiate the wireless sensing prior to obtaining the at least one first frame. In further implementations, the method, apparatuses, and computer-readable medium may include operations, features, means, or instructions in which the request indicates desired parameters for the wireless sensing.

In some implementations, the method, apparatuses and computer-readable medium can include participating in the wireless sensing and further may include operations, features, means, or instructions for measuring data in accordance with the parameters and then providing, to the at least one wireless node, the data and obtaining, from the at least one wireless node, a third frame including a sensing result generated based on the data.

In some implementations, the method, apparatuses, and computer-readable medium may include operations, features, means, or instructions in which the parameters include at least one of a parameter indicating when the wireless sensing is to start, a parameter indicating a duration of the wireless sensing or a parameter indicating a waveform definition for a signal in a portion of the at least one second frame.

In some implementations, the method, apparatuses, and computer-readable medium may include operations, features, means, or instructions in which the at least one wireless node includes a plurality of wireless nodes and the parameters indicate a schedule for outputting the at least one second frame for transmission from different ones of the plurality of wireless nodes for the wireless sensing. In further implementations, the method, apparatuses, and computer-readable medium may include operations, features, means, or instructions in which the schedule calls for simultaneous transmission of the at least one second frame by at least two of the plurality of wireless node and at least a portion of each of the second frames includes at least one orthogonal signal. In further implementations, the method, apparatuses, and computer-readable medium may include operations, features, means, or instructions in which the at least one orthogonal signal includes one or more Golay codes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a system diagram of an example network in which one or more aspects of the subject matter described in this disclosure can be implemented.

FIG. 2 shows a block diagram of example devices shown in FIG. 1.

FIG. 3 shows an example of multi-static wireless sensing system.

FIG. 4 shows a flow diagram of example operations for coordinating multi-static wireless sensing.

FIG. 5 shows a flow diagram of example operations for participating in multi-static wireless sensing.

FIGS. 6A-6D show examples of multi-static wireless sensing.

FIG. 7 shows a flow diagram of example operations for coordinating wireless sensing.

FIG. 8 shows a flow diagram of example operations for participating in wireless sensing.

FIGS. 9 and 10 show examples of station-initiated multi-static wireless sensing.

Like reference numbers and designations in the various drawings indicate like elements

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, and the IEEE 802.3 Ethernet standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

One or more innovative aspects of the subject matter described in this disclosure can help enhance sensing based on WiFi signals, referred to herein as wireless sensing or WiFi sensing. WiFi sensing involves one or more devices transmitting WiFi signals, while one or more devices use reflections of those signals to map and measure the environment. For example, WiFi sensing may be used to obtain rough dimensions of a room, identify stationary objects in a room, or detect objects (such as people) moving into, out of, or within a room. Multi-static WiFi sensing refers to the case when at least two devices are simultaneously involved (such as one or more transmitting and one or more receiving). Techniques presented herein help coordinate devices involved in multi-static WiFi sensing. As will be described in greater detail below, a device acting as a coordinator may provide WiFi sensing setup parameters (such as a schedule that indicates when various participants are to transmit, details about a transmitted waveform, repetition, and the like).

There are various advantages to multi-static WiFi sensing performed in accordance with aspects of the subject matter described in this disclosure. One advantage is that multi-static WiFi sensing may be accomplished using existing infrastructure and devices (such as with little or no hardware changes required for devices). Another advantage is that the coordination of devices involved in multi-static WiFi sensing proposed herein may result in more accurate sensing results. For example, by removing or reducing the possibility of interference by staggering transmissions in time or using orthogonal signals for the sensing. Still another advantage is that, in some implementations, the amount of network traffic may be limited by allowing multiple devices to receive and measure reflected signals simultaneously, which may be particularly useful when devices are making their own measurements (such as for their own purposes, like in the case of a robot attempting to navigate a room or detect an object in the room). Still another advantage is that multi-static sensing (such as with at least two transmitters and at least two receiver) facilitates mapping of “hidden” objects that may be obscured from the viewpoint of a device initiating the wireless sensing.

The teachings herein may be incorporated into (such as implemented within or performed by) a variety of wired or wireless apparatuses (such as nodes). In some aspects, a wireless node implemented in accordance with the teachings herein may include an access point (AP) or an access terminal (AT).

An AT may include, be implemented as, or known as a subscriber station, a station (or STA), a subscriber unit, a mobile station, a remote station, a remote terminal, a user terminal (UT), a user agent, a user device, user equipment, a user station, or some other terminology. In some implementations, an access terminal may include a cellular telephone, a cordless telephone, a Session Initiation Protocol (SIP) phone, a wireless local loop (WLL) station, a personal digital assistant (PDA), a handheld device having wireless connection capability, a Station (STA), or some other suitable processing device connected to a wireless modem. Accordingly, one or more aspects taught herein may be incorporated into a phone (such as a cellular phone or smart phone), a computer (such as a laptop), a portable communication device, a portable computing device (such as a personal data assistant), an entertainment device (such as a music or video device, or a satellite radio), a global positioning system device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communication link.

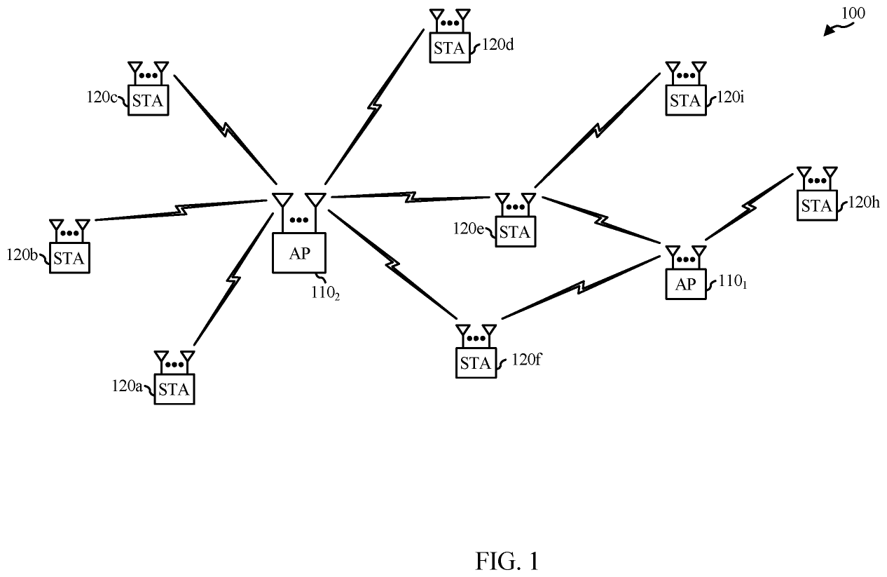

FIG. 1 shows a system diagram of an example network in which one or more aspects of the subject matter described in this disclosure can be implemented. For example, an access point 110 shown in FIG. 1 may coordinate different devices (such as stations 120 or other APs) participating in multi-static sensing. The multi-static sensing may be performed to map an environment (such as a room) or detect an object (not shown) present or moving within the environment. In the illustrated example, there are two APs, AP 110₁ serving a first basic service set (BSS) and AP 110₂ serving a second BSS. Examples described below illustrate how such APs may coordinate wireless sensing involving stations in different BSSs.

For simplicity, only one access point 110 is shown in FIG. 1. An access point is generally a fixed station that communicates with the user terminals and also may be referred to as a base station or some other terminology. Access points (APs) such as AP 110₁ and AP 110₂ may include, be implemented as, or known as a Node B, a Radio Network Controller (RNC), an evolved Node B (eNB), a Base Station Controller (BSC), a Base Transceiver Station (BTS), a Base Station (BS), a Transceiver Function (TF), a Radio Router, a Radio Transceiver, a Basic Service Set (BSS), an Extended Service Set (ESS), a Radio Base Station (RBS), or some other terminology. A user terminal may be fixed or mobile and also may be referred to as a mobile station, a station (STA), a wireless device or some other terminology. AP 110₁ or AP 110₂ may communicate with one or more stations 120 at any given moment on the downlink and uplink. The downlink (i.e., forward link) is the communication link from the access point to the user terminals, and the uplink (i.e., reverse link) is the communication link from the user terminals to the AP 110₁ or AP 110₂. A user terminal also may communicate peer-to-peer with another user terminal.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected stations 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 also may utilize a single carrier or multiple carriers for transmission. Each user terminal may be equipped with a single antenna (such as in order to keep costs down) or multiple antennas (such as where the additional cost can be supported). The system 100 also may be a TDMA system if the stations 120 share the same frequency channel by dividing transmission/reception into different time slots, each time slot being assigned to different station 120.

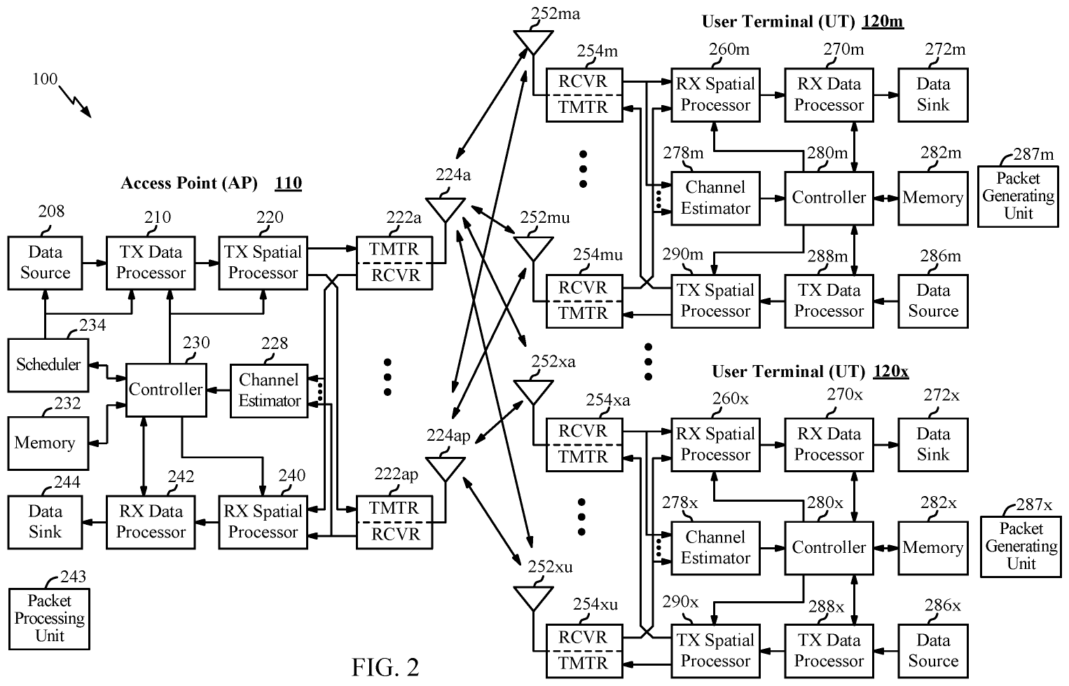

FIG. 2 shows a block diagram of example devices shown in FIG. 1. FIG. 2 illustrates a block diagram of access point 110 and two stations 120m and 120x in MIMO system 100. The access point 110 is equipped with Nₜ antennas 224a through 224t. Station 120m is equipped with N_{ut,m} antennas 252ma through 252mu, and station 120x is equipped with N_{ut,x} antennas 252xa through 252xu. The access point 110 is a transmitting entity for the downlink and a receiving entity for the uplink. Each station 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each station 120 selected for uplink transmission, a TX data processor 288 receives traffic data from a data source 286 and control data from a controller 280. TX data processor 288 processes (such as encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (such as converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (such as demodulates, deinterleaves, and decodes) each recovered uplink data symbol stream in accordance with the rate used for that stream to obtain decoded data. The decoded data for each user terminal may be provided to a data sink 244 for storage or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (such as encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each station 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (such as demodulates, deinterleaves and decodes) the recovered downlink data symbol stream to obtain decoded data for the user terminal.

At each station 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (such as the downlink or uplink eigenvectors, eigenvalues, SNR estimates, and so on) to the access point. Controllers 230 and 280 also control the operation of various processing units at access point 110 and station 120, respectively.

As noted above, WiFi sensing involves one or more devices transmitting WiFi signals, while one or more devices use reflections of those signals to map and measure the environment. Such sensing may take place in systems operating in various bandwidths, including bandwidths considered high frequency (such as mmWave) as well as lower frequency bandwidths.

There are different types of WiFi sensing that may be distinguished by the number of devices or their involvement. Monostatic WiFi Sensing is a system where the same WiFi device transmits the WiFi signal and receives the reflections to map the environment. This is similar to the mode of operation as in conventional radar. Multi-static WiFi sensing generally uses the same principles as the multi-static radar, where one or more devices transmit and one or more devices receive and there are two or more devices simultaneously involved.

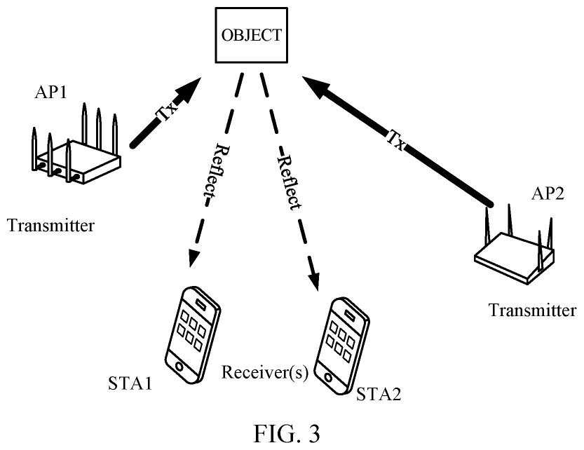

FIG. 3 shows an example of multi-static wireless sensing system. WiFi sensing may involve the transmission and monitoring reflections of what might be considered standard WiFi PHY signals (such as frames or packets). In the example illustrated in FIG. 3, two APs (AP1 and AP2) transmit while two stations (STA1 and STA2) monitor for reflections off an object. The environment shown in FIG. 3 may be considered passive, where the WiFi system uses the signals reflections to map and measure the environment. In other words, WiFi sensing effectively operates WLAN technologies in a radar mode for capturing a transmitted signal reflected by nearby objects. In some cases, a device participating in WiFi sensing may operate in a full-duplex mode, allowing one antenna(s) to transmit while the other antenna(s) are receiving (such as AP1 and AP2 also can monitor for reflections of their own transmissions).

Any suitable techniques may be used to detect and process reflections. Reflections may be detected, for example, based on a cross-correlation based on one or more sequences in transmitted frames (such as in a channel estimation field). The detection may be based on the cross-correlation (CC) results. For example, the CC may be performed to detect reflections and scatters surrounding the wireless node. These reflections may appear as a new tap in the CC output. The wireless node may generate (such as based on the CC results) a table including a distance, angle, material classification, and speed for each target (such as a detected object). Distance may be determined, for example, by measuring a round trip time for the reflecting wave to return to the receiving antenna of the wireless node. In some cases, a sensing device may determine an angle or arrival of a reflected frame, and based on the angle of arrival, the device may generate position information or three dimensional measurement information (such as based on a known location of a transmitting device, the sensing device, or object the frame reflected off). In some cases, a sensing device may determine a direction of motion of an object. In some cases, multiple sensing device may provide raw measurement data for a central device (such as an AP) to process and determine position sensor data (such as position/location/direction).

One of the challenges in multi-static radar, such as the multi-static WiFi sensing system shown in FIG. 3, is the coordination between the different stations, for example, to establish which devices are transmitting (and when) and which devices are listening. One way to address the challenge of coordination between the different stations is by using proprietary communication between the stations. Unfortunately, these solutions add complexity and cost in terms of signaling overhead. Another challenge of multi-static is time synchronization between devices (such as so a receiving device can accurately determine when a reflected packet was transmitted). One solution for time synchronization is to use very accurate time sources (such as common clock sources or atomic clocks). Unfortunately, this solution adds complexity and cost in terms of hardware.

One innovative aspect of the subject matter described in this disclosure utilizes WiFi communication to achieve the coordination between the different stations involved in multi-static WiFi sensing and to achieve coarse time synchronization between them. As used herein, coarse time synchronization generally means that stations know when the measurement frame is expected, but not the accurate time which is needed for synchronizing measurements from different devices.

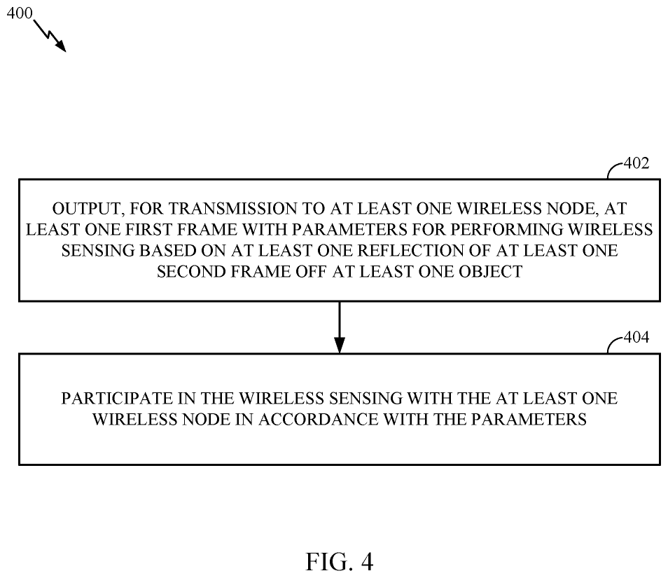

FIG. 4 shows a flow diagram of example operations 400 for coordinating multi-static wireless sensing. Operations 400 may be performed, for example, by any type of device acting in the capacity of a coordinator, such as one of the APs shown in FIGS. 1-3, to coordinate multi-static sensing involving stations 120 or other APs.

Operations 400 begin, at 402, by outputting, for transmission to at least one wireless node, at least one first frame with (such as sensing setup) parameters for performing (such as multi-static) wireless sensing based on at least one reflection of at least one second frame off at least one object. The frame including the sensing setup parameters may be a conventional data frame and may be sent, for example, over a communication link established by an AP with all the STAs involved in the multi-static WiFi sensing. The AP and STAs may have performed beamforming, exchanged capabilities, and established encryption keys, as part of establishing the link. In some cases, the AP may receive acknowledgments from each station (and may re-send the parameters if an acknowledgment is not received or a negative acknowledgment is received).

The WiFi sensing setup parameters may include various parameters, such as when the sensing starts (TxOP start time), duration of the sensing (TxOP duration), and definitions of the waveform used. For example, the definitions of the waveforms used may indicate a selection between different waveforms, a number of repetitions (if any), and the like. The parameters also may indicate a definition of the scheduling between stations (such as in the case when a signal is alternatively transmitted from multiple sources such as AP1 and AP2 in FIG. 3).

At 404, the coordinator participates in the wireless sensing with the at least one wireless node in accordance with the parameters. As will be described in greater detail below, the coordinator may participate by transmitting one or more frames (whose reflections will be monitored and measured) or by monitoring for reflections itself. In other words, depending on the implementation, the coordinator may be a transmitter, a receiver, or both.

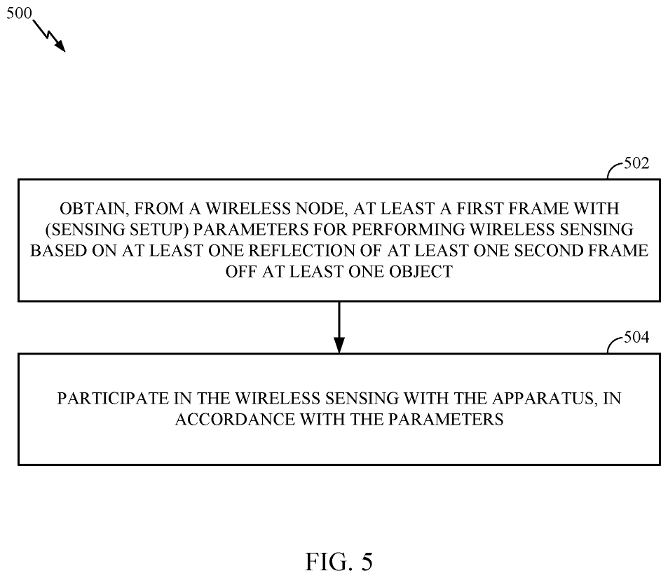

FIG. 5 shows a flow diagram of example operations 500 for participating in multi-static wireless sensing. Operations 500 may be performed, for example, by a station (such as STA1 or STA2 in FIG. 3) participating in multi-static WiFi sensing with an AP (coordinator) performing operations 400 described above.

Operations 500 begin, at 502, by obtaining, from a wireless node, at least a first frame with (sensing setup) parameters for performing wireless sensing based on at least one reflection of second frames off at least one object. At 504, the station participates in the wireless sensing with the apparatus, in accordance with the parameters.

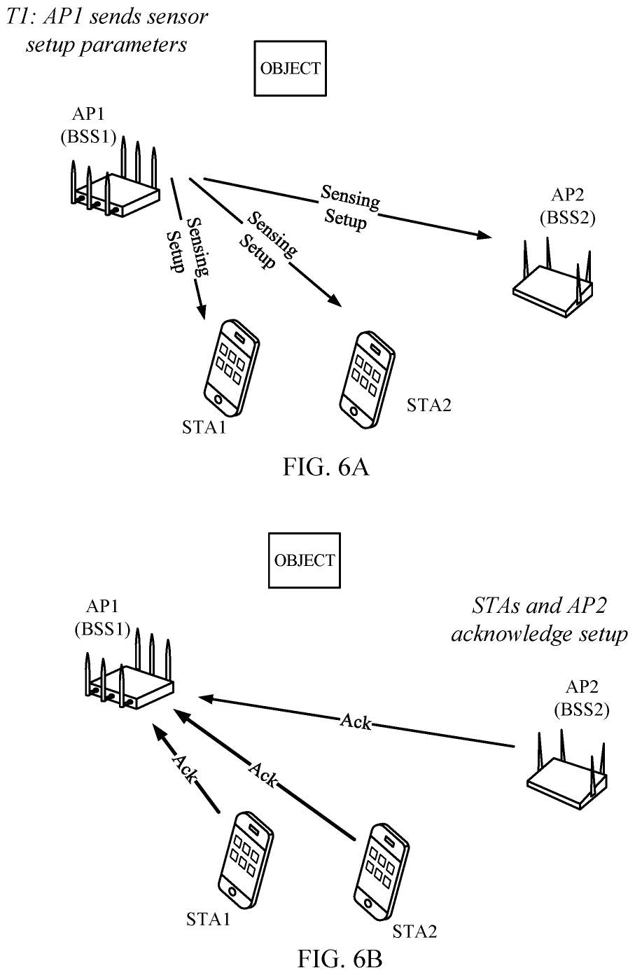

Exactly how the multi-static WiFi sensing is performed and which actions are taken by which device(s) may depend on the particular implementation. In some cases, an AP may take actions such as initiating sensing and transmitting frames while one or more (non-AP) STAs monitor for reflections. In other cases, a STA may initiate wireless sensing and may even transmit frames while APs monitor for reflections. As will be described below, there are various implementations possible based on the WiFi architecture, one of which is shown in FIGS. 6A-6D.

FIGS. 6A-6D show examples of multi-static wireless sensing. In the examples shown, an AP (AP1) is acting as an initiator of the multi-static sensing.

As shown in FIG. 6A, AP1 sends sensor setup parameters to the various devices participating in the multi-static sensing (such as STA1 and STA2). As noted above, the parameters may indicate when the sensing starts, a duration of the sensing, definitions of the waveform(s) used, and an indication of scheduling between stations (such as in this example AP1 and AP2 both transmit). The parameters may be sent via a standard communication link the STAs. While not shown, an additional STA belonging to BSS 2 may also participate in the wireless sensing. In such a case, AP2 may send the setup parameters (as it received from AP1) to that station.

In some cases, the initiator and other devices participating in the multi-static may be members of the same BSS (such as AP1 may serve BSS1 and STA1 and STA2 may be associated with BSS1). In other cases, the area scanned may be covered by multiple APs (such as AP2 serving BSS2). In this case, the initiator can be one of the APs (as in the example shown in FIG. 6A) or can be a STA associated with one of the APs. When other APs participate in multi-static sensing, those APs may need to effectively act as a station (such as maintain a STA stack) in order to communicate with other APs over the air (OTA). And, as noted above, AP2 may then perform a setup phase for STAs in BSS2.

As illustrated in FIG. 6B, in some cases, the AP initiating the WiFi sensing may receive acknowledgments from the devices after sending them setup parameters. The WiFi sensing setup acknowledgment may be sent from the devices receiving the setup and acknowledging (or negatively acknowledging) receipt of the parameters and their readiness to participate in the sensing. While not illustrated, in some cases, the communication for sensing setup may include some more negotiation, for example, regarding the start time. In any case, after setup is complete, the participating AP(s) and STA(s) will perform the WiFi sensing according to the setup.

For example, as illustrated in FIG. 6C, AP1 may begin (at time T1) to transmit a frame or frames (to “illuminate the environment”), while STA1 and STA2 monitor for reflections of those frames. As illustrated in FIG. 6D, at a different time (T2), AP2 begins to transmit a frame or frames (to “illuminate the environment”), while STA1 and STA2 monitor for reflections of those frames transmits. As illustrated, AP2 may be prompted to begin illuminating the environment based on a request from AP1. In some cases, two APs may be able to transmit simultaneously using orthogonal signals in the frames (such as a Golay code may allow for simultaneous transmission by two APs).

During the measurement period, each participating (AP or non-AP) station transmits signals according to the setup or performs measurement of received signals. These can be simultaneously done or not all according to the setup. In some cases, part of the measurement may include reception of the signal from the transmitter(s) using line of sight (LOS) and LOS beamforming for accurate timing synchronization.

Performing the measurements may include reception of the reflections, possibly antenna module switching, and different beamforming setups and repetitions. The measurement also may include reception of multiple simultaneous transmissions (when orthogonal signals are used). The measurement process also may include time synchronization compensation, averaging, and other processing which may be station dependent.

In this example, each STA that was instructed to perform measurement sends the measurement results to the initiator AP. In other words, the (“raw”) measurement data can be collected by the STAs, while the processing of the data to generate a sensing result (such as a map of a space or location of an object) is done at the AP (or another initiator STA). In cases the AP is not an initiator, it may send the results to the initiator STA (or to another AP).

In some cases, an AP may gather measurement data from multiple reporting STAs and send the measurement data to an initiator station. In some other cases, each STA may process their own raw measurements to generate a sensing result which may be useful in some cases (such as a robot entering a room to detect an object).

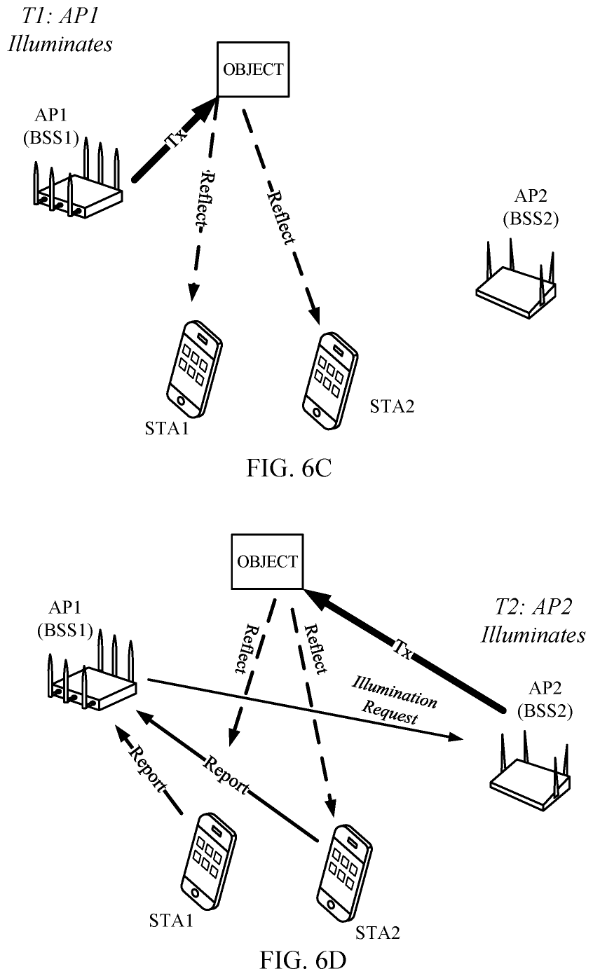

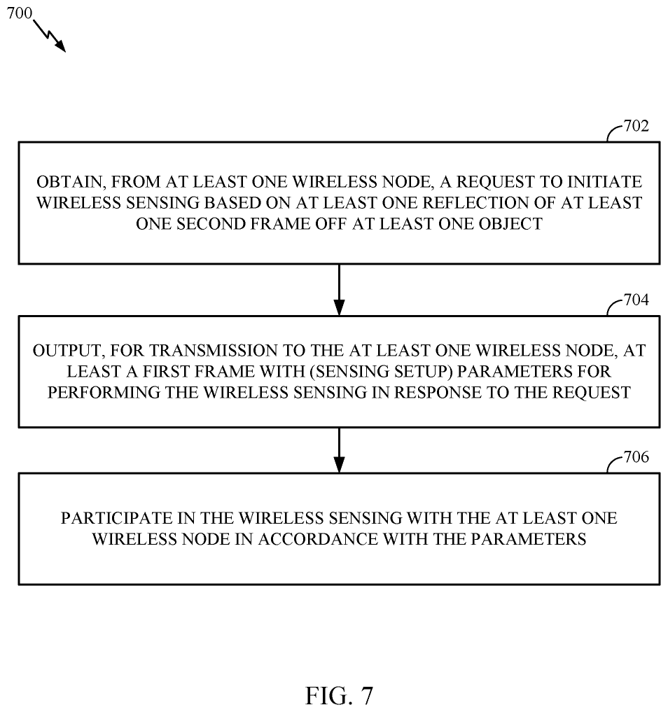

In some cases, a STA may initiate multi-static sensing and all the participating STAs (or APs) may be in the same BSS. In some cases, the initiating STA may indicate (in the request) optional parameters for the measurement setup. FIGS. 7 and 8 illustrate flow diagrams for an example of STA-initiated wireless sensing.

FIG. 7 shows a flow diagram of example operations 700 for coordinating wireless sensing. Operations 700 may be performed, for example, by any type of device acting in the capacity of a coordinator, such as one of the APs shown in FIGS. 1-3, to coordinate multi-static sensing involving stations 120 or other APs.

Operations 700 begin, at 702, by obtaining, from at least one wireless node, a request to initiate wireless sensing based on at least one reflection of at least one second frame off at least one object. At 704, the AP outputs, for transmission to the at least one wireless node, at least a first frame with (sensing setup) parameters for performing the wireless sensing in response to the request. At 706, the AP participates in the wireless sensing with the at least one wireless node in accordance with the parameters.

FIG. 8 shows a flow diagram of example operations 800 for participating in wireless sensing. Operations 800 may be performed, for example, by a station (such as STA1 or STA2 in FIG. 3) requesting to participate in multi-static WiFi sensing with an AP (coordinator) performing operations 700 described above.

Operations 800 begin, at 802, by outputting, for transmission to at least one wireless node, a request to initiate wireless sensing based on at least one reflection of at least one second frame off at least one object. At 804, the station obtains, from the apparatus, at least a first frame with (sensing setup) parameters for performing wireless sensing. At 806, the station participates in the wireless sensing in accordance with the parameters.

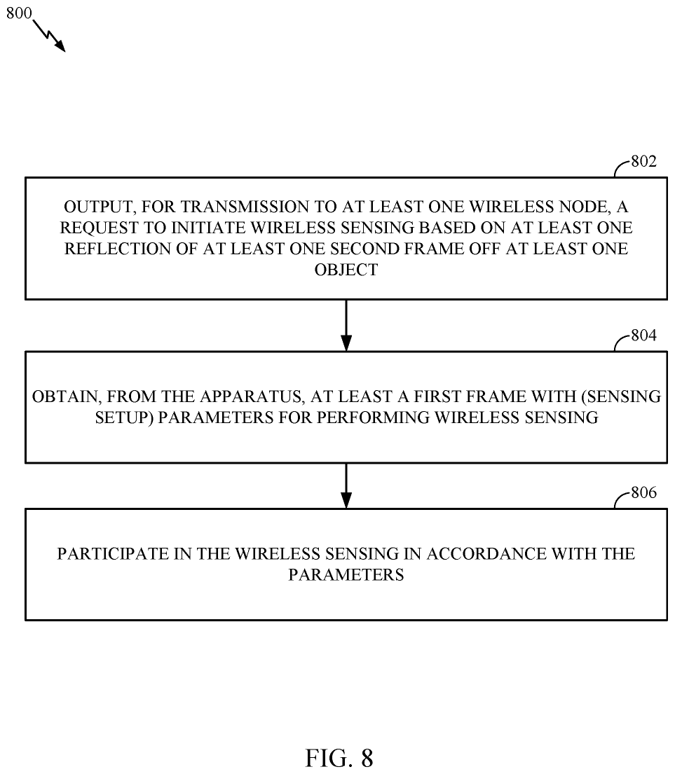

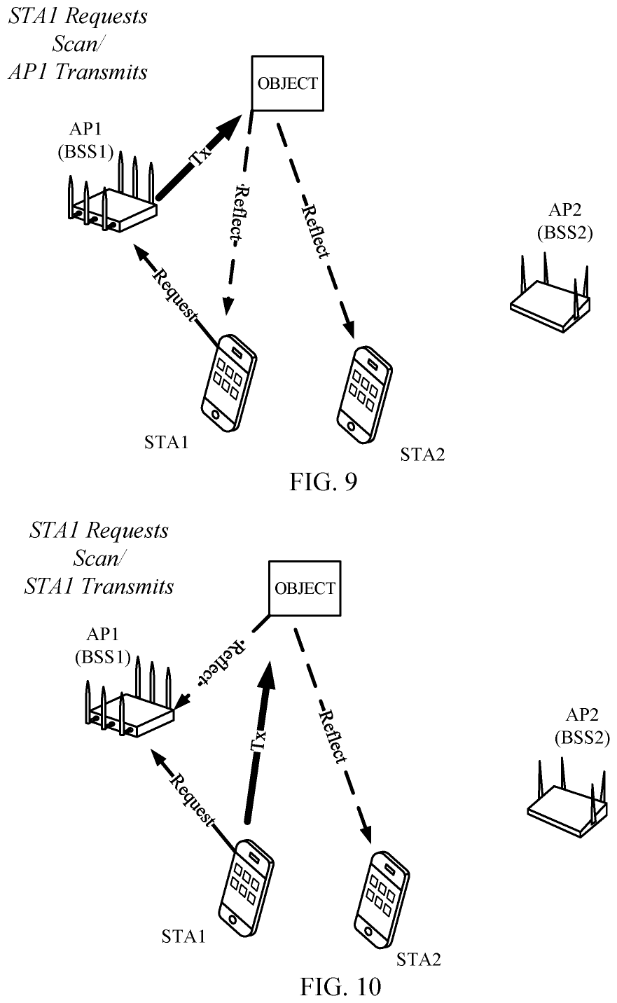

FIGS. 9 and 10 show examples of station-initiated multi-static wireless sensing. While the STA initiates the wireless sensing, depending on the particular implementation, the request may be for the AP to transmit (illuminate the environment). As an alternative, or in addition, the request may be for wireless sensing where the STA (sending the request) transmits.

In the example shown in FIG. 9, the requesting station (STA1) sends a request to AP1. While not shown, AP1 responds to the request with sensor setup parameters (to all participating stations). As noted above, the request may indicate desired sensor setup parameters. In any case, the sensing may occur with AP1 transmitting, while stations STA1 and STA2 monitor for reflections.

STA1 and STA2 may generate and report measurement data as noted above. In some cases, AP1 may process the measurement data and provide a generated result to the initiator (STA1). In some other cases, the measurement data may be collected from the various measuring stations and the collected measurement data may be sent to the initiator for processing to generate a sensing result.

FIG. 10 shows an example where the initiating station (STA1) is also a transmitter. In the example shown, AP1 and STA2 may monitor for reflections while STA1 transmits. AP1 and STA2 may process and report measurements as noted above. The examples shown in FIGS. 9 and 10 may be extended so that AP2 is included to participate in the wireless sensing (such as a transmitter or a receiver).

In some implementations, when a number of devices that desire sensing data, optimizations may be made to reduce the load on the wireless medium. For example, when multiple devices require detailed, frequent and low latency environment monitoring using the standard monitoring, each initiating device may access the medium for its environment monitoring using. This access by multiple devices potentially generates a large load of the medium, with the load being proportional to the requirements and the number of initiating devices.

Without the coordination presented herein, each device desiring wireless sensing may be responsible for its own measurements. If the devices are not coordinating, their transmissions or reporting may interfere with each other. In some cases, even if the devices are coordinated to mitigate interference, each device may get less medium access than desired.

In such potentially high-load cases, it may be advantageous for all the devices to use a common monitoring signal (such as to all monitor the same transmission). In other words, an environment (such as a room) may be scanned (“illuminated”) with common transmitted signals (from one or more devices), while multiple devices are monitoring the reflections of these signals in parallel.

If only initiator devices (requesting wireless sensing) are monitoring the medium (even if there are multiple transmitters) the medium utilization may be (more or less) fixed and does not increase with the number of devices. If more than one device is to receive measurement data or sensing results, the medium load may be slightly increased due to the results transmissions.

Scenarios where the initiating devices do not transmit, but only monitor for reflections may be referred to as passive WiFi sensing. In some cases, passive WiFi sensing may assume that one or more stations (usually APs) are mounted at fixed and known locations in an environment to be sensed, such as a room (or some other space). It also may be assumed that these stations at known locations are connected via WiFi or other means. The stations initiating the WiFi sensing may be moving within (or into) the room. Each of these STAs may already be associated with one of the AP.

For the situation where the environment (the room) is scanned by one or more transmitting devices and one or more initiator STAs are monitoring the environment, the initiator STA (each of them) may communicate with the associated AP to request for the scan. As noted above, the APs may send (such as via standards wireless communication links) the requesting STA(s) parameters about the upcoming scan(s) of the medium. The parameters may include information about each transmitter, scheduling information or information about the transmitted signal (such as waveform or repetition). The AP(s) via any method coordinate the actual transmissions as noted above (such as via TDMA or use of orthogonal signals).

In some cases, each STA may operate somewhat independently. For example, each initiating STA may perform measurements, collect the data, and process it to generate the sensing result. This may be useful when each STA can use its own results, for example, in a scenario where each STA corresponds to a robot that is attempting to locate an object or navigate the environment being sensed. This approach may help enable each STA to actively monitor the surrounding environment as viewed from its own perspective.

In some cases, one or more STAs may perform their own illumination (transmission) and scan. For this case, the AP(s) may inform each initiator STA when and with what parameters to illuminate in order to avoid interference between stations (inter-STA interference).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

The various operations of methods described above may be performed by any suitable means capable of performing the corresponding functions. The means may include various hardware or software component(s) or module(s), including, but not limited to a circuit, an application specific integrated circuit (ASIC), or processor.

Means for receiving or means for obtaining may include a receiver (such as the receiver unit 222) or an antenna(s) 224 of the access point 110 or the receiver unit 254 or antenna(s) 252 of the station 120 illustrated in FIG. 2. Means for transmitting or means for outputting may include a transmitter (such as the transmitter unit 222) or an antenna(s) 224 of the access point 110 or the transmitter unit 254 or antenna(s) 252 of the station 120 illustrated in FIG. 2. Means for participating, means for providing, means for selecting or means for processing may include a processing system, which may include one or more processors, such as the RX data processor 242, the TX data processor 210, the TX spatial processor 220, RX spatial processor 240, or the controller 230 of the access point 110 or the RX data processor 270, the TX data processor 288, the TX spatial processor 290, RX spatial processor 260, or the controller 280 of the station 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1.-60. (canceled)

61. An apparatus for wireless communications, comprising:
an interface configured to output, for transmission to at least one wireless node, at least one first frame with parameters for performing wireless sensing based on at least one reflection of at least one second frame off at least one object; and
a processing system configured to participate in the wireless sensing with the at least one wireless node in accordance with the parameters.

62. The apparatus of claim 61, wherein the participation in the wireless sensing comprises outputting the at least one second frame for transmission.

63. The apparatus of claim 61, wherein the participation in the wireless sensing comprises monitoring for reflections of the at least one second frame.

64. The apparatus of claim 61, wherein:
the interface is further configured to obtain, from the at least one wireless node, data from the wireless sensing performed in accordance with the parameters; and
the processing system is further configured to process the data to generate a sensing result, wherein the processing is based on known or estimated one or more locations of the at least one wireless node.

65. The apparatus of claim 64, wherein:
the sensing result indicates a position or presence of the at least one object; or
the sensing result represents a map of an environment in which the wireless sensing is performed.

66. The apparatus of claim 61, wherein the interface is further configured to obtain, from one of the at least one wireless node, a request to initiate the wireless sensing prior to outputting the first frame for transmission.

67. The apparatus of claim 66, wherein the parameters include a schedule that indicates:
when the one wireless node that requested initiation of the wireless sensing is to output the at least one second frame for transmission; and
when the at least one wireless node, other than the one wireless node that requested initiation of the wireless sensing, is to output the at least one second frame for transmission during the wireless sensing.

68. The apparatus of claim 66, wherein the processing system is further configured to select the parameters, wherein:
the request indicates desired parameters for the wireless sensing; and
the selection of the parameters is, at least in part, based on the desired parameters indicated in the request.

69. The apparatus of claim 66, wherein:
the interface is further configured to obtain, from the at least one wireless node, data from the wireless sensing performed in accordance with the parameters;
the processing system is further configured to process the data to generate a sensing result; and
the interface is further configured to output, for transmission to the wireless node that sent the request, a third frame with the sensing result.

70. The apparatus of claim 61, wherein the parameters comprise at least one of:
a parameter indicating when the wireless sensing is to start;
a parameter indicating a duration of the wireless sensing; or
a parameter indicating a waveform definition for a signal in a portion of the at least one second frame.

71. The apparatus of claim 61, wherein the parameters include a schedule that indicates when the apparatus is to output the at least one second frame for transmission during the wireless sensing.

72. The apparatus of claim 61, wherein:
the at least one wireless node comprises a plurality of wireless nodes; and
the parameters indicate a schedule for outputting the at least one second frame for transmission from different ones of the plurality of wireless nodes for the wireless sensing.

73. The apparatus of claim 72, wherein:
the schedule calls for simultaneous transmission of the at least one second frame by at least two of the plurality of wireless node; and
at least a portion of each of the second frames comprises at least one orthogonal signal.

74. The apparatus of claim 73, wherein the at least one orthogonal signal comprises one or more Golay codes.

75. An apparatus for wireless communications, comprising:
an interface configured to obtain, from at least one wireless node, at least one first frame with parameters for performing wireless sensing based on at least one reflection of at least one second frame off at least one object; and
a processing system configured to participate in the wireless sensing with the at least one wireless node in accordance with the parameters.

76. The apparatus of claim 75, wherein the participation in the wireless sensing comprises:
measuring data in accordance with the parameters; and
providing the data to the at least one wireless node.

77. The apparatus of claim 75, wherein the participation in the wireless sensing comprises outputting the at least one second frame for transmission.

78. The apparatus of claim 75, wherein participating in the wireless sensing comprises monitoring for reflections of the at least one second frame.

79. The apparatus of claim 78, wherein the parameters include a schedule that indicates when the apparatus is to output the at least one second frame for transmission during the wireless sensing.

80. The apparatus of claim 75, wherein the parameters include a schedule that indicates at least one of:
when the apparatus is to output the at least one second frame for transmission; or
when the at least one wireless node is to output at least one second frame for transmission during the wireless sensing.

81. The apparatus of claim 75, wherein:
the participation in the wireless sensing comprises measuring data in accordance with the parameters; and
the apparatus further comprising processing the data to generate a sensing result.

82. The apparatus of claim 81, wherein the processing is based on known or estimated one or more locations of the at least one wireless node.

83. The apparatus of claim 81, wherein the sensing result indicates a position or presence of the at least one object and further wherein the at least one object comprises at least one person.

84. The apparatus of claim 75, wherein the interface is further configured to output, for transmission to the at least one wireless node, a request to initiate the wireless sensing prior to obtaining the at least one first frame.

85. The apparatus of claim 84, wherein:
the request indicates desired parameters for the wireless sensing.

86. The apparatus of claim 75, wherein:
the participation in the wireless sensing comprises measuring data in accordance with the parameters;
the processing system is further configured to provide, to the at least one wireless node, the data; and
the interface is further configured to obtain, from the at least one wireless node, a third frame including a sensing result generated based on the data.

87. The apparatus of claim 75, wherein the parameters comprise at least one of:
a parameter indicating when the wireless sensing is to start;
a parameter indicating a duration of the wireless sensing; or
a parameter indicating a waveform definition for a signal in a portion of the at least one second frame.

88. The apparatus of claim 75, wherein:
the at least one wireless node comprises a plurality of wireless nodes; and
the parameters indicate a schedule for outputting the at least one second frame for transmission from different ones of the plurality of wireless nodes for the wireless sensing.

89. The apparatus of claim 88, wherein:
the schedule calls for simultaneous transmission of the at least one second frame by at least two of the plurality of wireless node; and
at least a portion of each of the second frames comprises at least one orthogonal signal.

90. The apparatus of claim 89, wherein the at least one orthogonal signal comprises one or more Golay codes.

91.-120. (canceled)
